(19) United States
(12) Patent Application Publication
(10) Pub. No.: US 2001/0013105 A1
(43) Pub. Date: Aug. 9, 2001

(54) Method for routing test based on generation of random virtual networks

(76) Inventors: Sung Won Kang, Daejon-shi (KR); Jae Hwi Shin, Daejon-shi (KR)

Correspondence Address: MERCHANT & GOULD, P O BOX 2903, MINNEAPOLIS, MN, 55402-0903, US

(21) Appl. No.: 09/756,485

(22) Filed: Jan. 8, 2001

(30) Foreign Application Priority Data
Dec. 23, 1999 (KR) 1999-60875

(51) Int. Cl. G06F 11/26

(52) U.S. Cl. 714/43

(57) ABSTRACT

A method for routing test comprises the steps of: checking a test mode of the routing test by receiving the test mode by a user; recalling a stored virtual network or editing the virtual network, when the routing test is performed by using a virtual network defined by the user; generating new virtual networks recursively based on respective information, when the routing test is performed by using a virtual network generated by a virtual network generator included in a routing test system; operating a target protocol of a virtual router and a router under test of the virtual network; and transmitting a packet considering a portion of the virtual network as a destination address trough the router under test, and monitoring links of the router under test. A routing test system according to the present invention generates various network topologies as much as user wants through a network generator, and performs a routing test after transmitting information to make a target router verify the generated topologies. Thus, the target router can correct routing calculation for the respective network topologies.

### FIELD OF THE INVENTION

The present invention relates to a method for routing test, and more particularly to a method for routing test based on generation of random virtual networks in order to get an effect of a real test, by operating a router as if the router is located in real networks, although a single test system performs the routing test with coupling to the router.

### BACKGROUND OF THE INVENTION

Generally, a router is an equipment to transmit data from a transmitter host to a receiver host in networks. The router collects a piece of information related to topologies and link cost of a network of the router itself through a routing protocol, and forwards the information to the next router or the receiver host.

For more practical test on whether the router performs routing and forwarding functions properly, it is required to place the router in various locations of various networks in order to verify whether the router operates properly in any location.

However, to perform the test, several equipments (for example, routers and hosts) performing proper operations are necessary. Therefore, much cost and effort for performing the test itself is considered as one of problems the above method is facing.

### SUMMARY OF THE INVENTION

It is therefore an object of the present invention to provide a method for routing test based on generation of random virtual networks, in order that a target router performs a routing calculation correctly by generating various network topologies as much as a user wants through a network generator and performs the routing test after transmitting information to the router to verify the topologies.

In order to attain the above object, according to an aspect of the present invention, there is provided a method comprising the steps of: checking a test mode of the routing test by receiving the test mode by a user; calling a stored virtual network or editing the virtual network, when the routing test is performed by using a virtual network defined by the user; generating new virtual networks recursively based on respective information, when the routing test is performed by using a virtual network generated by a virtual network generator included in a routing test system; operating a target protocol of a virtual router and a router under test of the virtual network; and transmitting a packet considering a portion of the virtual network as a destination address trough the router under test; and, monitoring links of the router under test.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram for illustrating a structure of a target router to be tested and a test system, according to a preferred embodiment of the present invention;

FIG. 2 is a state diagram for illustrating connecting status of a random virtual network generated by a virtual network generator and a target router to be tested, according to a preferred embodiment of the present invention; and

FIG. 3 is a flowchart for illustrating a method of routing test according to a preferred embodiment of the present invention.

### DESCRIPTION OF THE PREFERRED EMBODIMENT

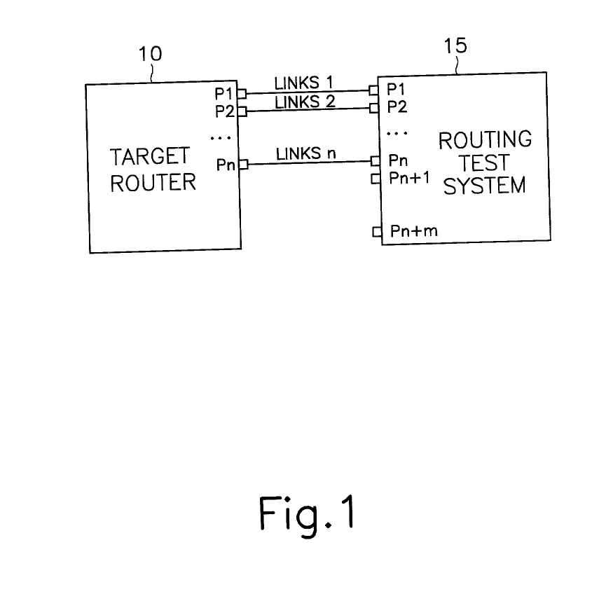

FIG. 1 is a block diagram for illustrating a structure of a target router to be tested 10 and a test system 15, according to a preferred embodiment of the present invention. Referring to FIG. 1, a target router 10 and a routing test system 15 comprise a plurality of network connection ports, respectively, and are connected one to one through the network connection ports.

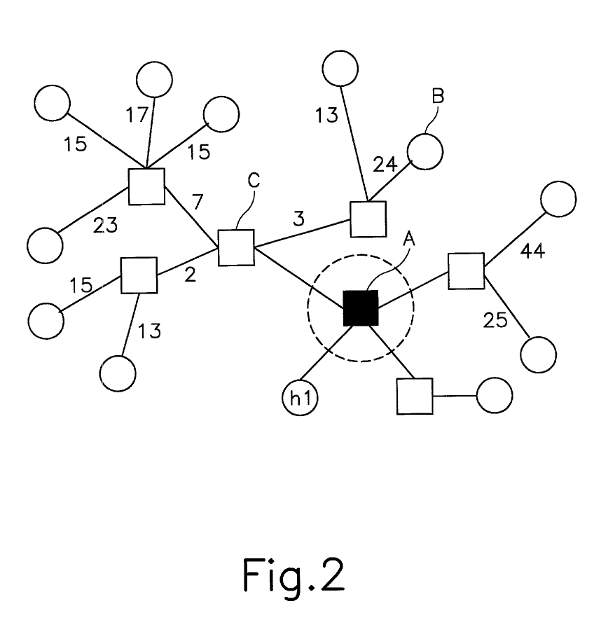

FIG. 2 is a state diagram for illustrating connecting status of a random virtual network generated by a virtual network generator and a target router to be tested, according to a preferred embodiment of the present invention. Referring to FIG. 2, “A” indicates a target router, “B” indicates a virtual host, and “C” indicates a virtual router, respectively. Reference numbers shown in FIG. 2 illustrate costs of generated links.

The routing test system 15 according to the present invention includes various network interface cards or ports. In addition, the routing test system 15 includes various routing protocols and network generators supported by such various network connection ports. The network generator generates a virtual network including a router under test (RUT).

Here, all of the routers excepting the RUT among the routers included in the virtual network are called virtual routers, and links between the virtual routers are called virtual links. In this case, all hosts generated by a virtual network generator are virtual hosts. FIG. 1 shows a virtual network including n virtual hosts and m virtual routers, wherein “link 1, . . . , link n” illustrate connections between a target router and a virtual host and “link n+1, . . . , link n+m” illustrate connections between a target router and a virtual router.

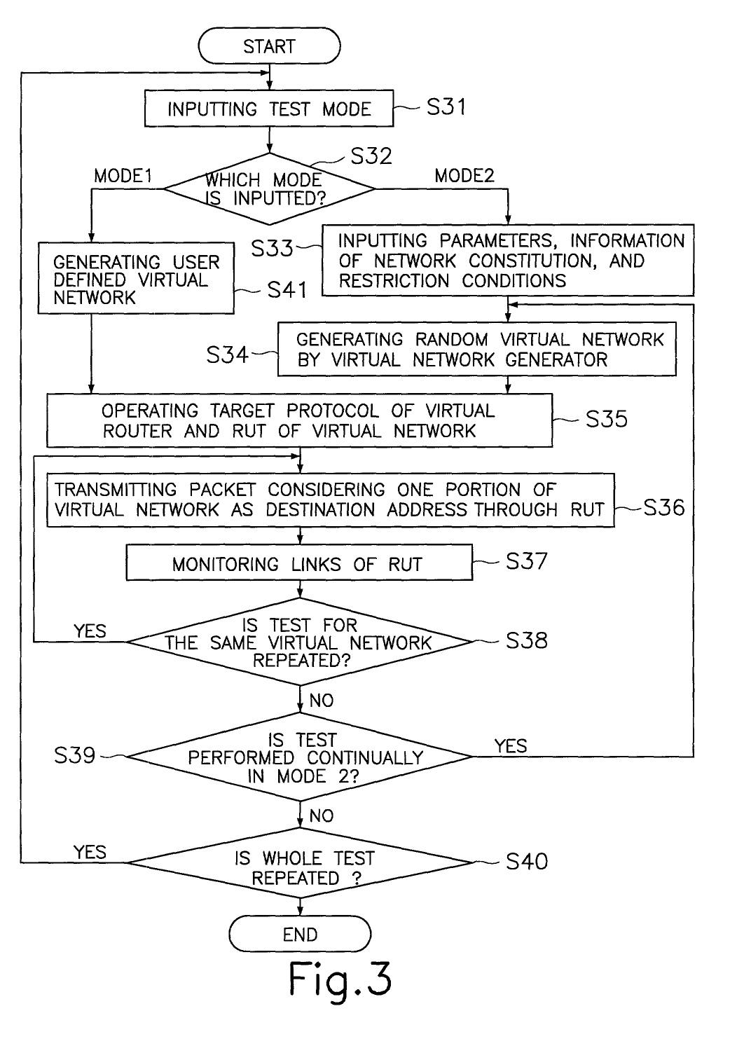

FIG. 3 is a flowchart for illustrating method of routing test according to a preferred embodiment of the present invention. Reference is now made to FIG. 3 to further discuss of a method for routing test according to the present invention. First of all, at step S31, test mode is inputted by a user. At step S32, it is checked the inputted test mode. If the current test mode is “mode 1”, the control flow proceeds to step S41, wherein a routing test using a user defined virtual network is performed. In this step, a routing test system for performing the routing test has a function for storing the virtual network. Thus, the stored virtual network can be recalled a new virtual network can be edited to use. In case that a new virtual network is edited, a user edits the virtual network through an editor. On the completion of defining of the virtual network according to above describe method, the control flow proceeds to step S35.

At step S35, here, a virtual router of the virtual network composed of the virtual router, RUT, link 1, . . . , link n+m, virtual links, and virtual hosts and a target protocol of the RUT are operated. As a result, emulation of the target routing protocol is performed in a port connected with link n+1, . . . , link n+m linking the virtual router with the RUT. In the virtual link, a virtual message is exchanged through communication between processors, and the target routing protocol is emulated. At this time, the routing test system waits for a predetermined time to input the information of a virtual topology to the RUT.

On the other hand, at step S32, if the current test mode is “mode 2”, a routing test using a virtual network generated by a virtual network generator is performed. To perform the routing test, parameters required to generate a random virtual network, such as, the number of network nodes, the number of whole links, the number of links coupled to the RUT, and the number of generated networks are inputted by a user in step S33. In addition, the user can input restriction conditions of a virtual network or a portion of the network as the information for network constitution, being generated by the virtual network generator. The virtual network generator repeatedly generates various networks as many as the number of generated networks in steps of S34 and S40, to satisfy the inputted conditions. When a virtual network is generated, the control flow then proceeds to step S35 to operate a target protocol of the virtual router and the RUT of the virtual network.

After operating the target protocol, a packet having one portion of the virtual network as a destination address is transmitted through the RUT, and links of the RUT are monitored to determine whether the packet is transmitted properly by a correct routing calculation in steps of S36 and S37. Then, if the user wants, the test is performed recursively on the identical virtual network in step S3 8. After completing the test for the identical virtual network, it is determined whether the test mode is “mode 2” and the virtual networks are not generated as many as the inputted number of the virtual networks by the user in step S39. If so, the control flow returns to step S35. If not, the control flow goes to step S40. At step S40, if the user wants the test to be repeated, the control flow returns to the step S31 to repeat the test.

As described above, the routing test system according to the present invention generates various network topologies as much as a user wants through a network generator, and performs a routing test after transmitting information to make a target router verify the generated topologies. Thus, the target router can correct routing calculation for the respective network topologies.

While the invention has been described in terms of an exemplary embodiment, it is contemplated that it may be practiced as outlined above with modifications within the spirit and scope of the appended claims.

What is claimed is:

1. A method for routing test comprising the following steps of:
checking a test mode of the routing test by receiving the test mode by a user;
recalling a stored virtual network or editing the virtual network, when the routing test is performed by using a virtual network defined by the user;
generating new virtual networks recursively based on respective information, when the routing test is performed by using a virtual network generated by a virtual network generator included in a routing test system;
operating a target protocol of a virtual router and a router under test of the virtual network; and
transmitting a packet having a portion of the virtual network as a destination address trough the router under test, and monitoring links of the router under test.

2. The method according to claim 1, wherein the virtual network generator can input information of network constitution and restriction conditions of the generated virtual network, and generates the virtual network randomly when a number of network nodes, a number of whole links, a number of links coupled to the router under test, the information of network constitution, and the restriction conditions are inputted to satisfy the inputted information and conditions.
